(19) United States
(12) Patent Application Publication
(10) Pub. No.: US 2026/0276855 A1
(43) Pub. Date: Sep. 17, 2026

(54) Z-SHAPED STEEL WIRE SEALED LOAD-BEARING DETECTION CABLE

(71) Applicant: HEBEI HUATONG WIRES & CABLES GROUP CO., LTD, TANGSHAN (CN)

(72) Inventors: BAOJUN JIANG, TANGSHAN (CN); SHUJUN ZHANG, TANGSHAN (CN); BAOLONG ZHANG, TANGSHAN (CN); LIANGHE SONG, TANGSHAN (CN); HUAIAN WANG, TANGSHAN (CN); LIMEI DOU, TANGSHAN (CN); YAFEI TIAN, TANGSHAN (CN); YANLI JI, TANGSHAN (CN); HANYUAN DONG, TANGSHAN (CN); BIN LI, TANGSHAN (CN); YONGHENG ZHANG, TANGSHAN (CN); ZHAOHUAN LIU, TANGSHAN (CN)

(21) Appl. No.: 19/465,826

(22) Filed: Jan. 30, 2026

Related U.S. Application Data
(63) Continuation of application No. PCT/CN2025/135933, filed on Nov. 19, 2025.

(30) Foreign Application Priority Data
Nov. 28, 2024 (CN) 202422918933.0

(51) Int. Cl. G01V 3/20; E21B 17/00

(52) U.S. Cl. CPC G01V 3/20; E21B 17/003

(57) ABSTRACT

Provided is a Z-shaped steel wire sealed load-bearing detection cable including a cable core and armor steel wire layers armored outside the cable core. The armor steel wire layers include an inner layer and an outer layer. The inner layer is formed by armoring circular inner-layer armor steel wires or Z-shaped inner-layer armor steel wires, and the outer layer is formed by armoring Z-shaped outer-layer armor steel wires. The circular inner-layer armor steel wires or the Z-shaped inner-layer armor steel wires are armored outside the cable core, and the Z-shaped outer-layer armor steel wires are armored outside the circular inner-layer armor steel wires or the Z-shaped inner-layer armor steel wires.

### CROSS-REFERENCE TO RELATED APPLICATION

This application is a continuation of International Patent Application No. PCT/CN2025/135933, filed on Nov. 19, 2025, which claims priority of the Chinese Patent Application No. 202422918933.0, filed on Nov. 28, 2024.

### TECHNICAL FIELD

The present disclosure relates to a Z-shaped steel wire sealed load-bearing detection cable, and belongs to the technical field of petroleum engineering oilfield logging cables.

### BACKGROUND

A load-bearing detection cable is a cable generally used during oilfield logging, and is used for downhole electrical measurements under mechanical load conditions. With a gradual increase in a downhole depth, pressures of oil and gas also increase gradually, which puts forward higher requirements for load capacity of cables and sealing of wellhead cables.

The outer-layer armor steel wires of the traditional load-bearing detection cable are circular, resulting in numerous gaps between the steel wires. During wellhead sealing, this necessitates filling with large amounts of sealing material, yet both the sealing effectiveness and efficiency remain very poor.

### SUMMARY

The present disclosure aims to provide a Z-shaped steel wire sealed load-bearing detection cable, which greatly reduces gaps between steel wires. Such cable is easily sealed after running in a well, so as to reduce an accident rate and solve the foregoing problem existing in the background.

A technical solution of the present disclosure is as follows:

A Z-shaped steel wire sealed load-bearing detection cable includes a cable core and armor steel wire layers armored outside the cable core, where the armor steel wire layers include an inner layer and an outer layer, the inner layer is formed by armoring circular inner-layer armor steel wires or Z-shaped inner-layer armor steel wires, the outer layer is formed by armoring Z-shaped outer-layer armor steel wires, the circular inner-layer armor steel wires or the Z-shaped inner-layer armor steel wires are armored outside the cable core, and the Z-shaped outer-layer armor steel wires are armored outside the circular inner-layer armor steel wires or the Z-shaped inner-layer armor steel wires.

Furthermore, the Z-shaped inner-layer armor steel wires and the Z-shaped outer-layer armor steel wires are armored in opposite directions.

Furthermore, the cable core includes a first insulation wire core, the first insulation wire core includes a first conductor and a first insulator, and the first insulator is extruded outside the first conductor.

Furthermore, the first insulation wire core includes a plurality of first insulation wire cores, the plurality of first insulation wire cores are stranded into a cable, a first layer is added in a middle of the cable core, and a first wrapping tape is wrapped outside the cable core.

Furthermore, the cable core includes an optical fiber unit, the optical fiber unit includes optical fibers, a grease filler, a steel tube jacket, and a lining layer, the steel tube jacket is sleeved outside the optical fibers, the grease filler is disposed between the steel tube jacket and the optical fibers, and the lining layer is disposed outside the steel tube jacket.

Furthermore, the cable core further includes second insulation wire cores, the second insulation wire cores are stranded circumferentially around the optical fiber unit to form a cable, a second filler layer is added in a middle of the cable core, and a second wrapping tape is wrapped outside the cable core.

Furthermore, each of the second insulation wire cores includes a second conductor and a second insulator, and the second insulator is extruded outside the second conductor.

Positive effects of the present disclosure are as follows. Another layer of Z-shaped outer-layer armor steel wires are armored outside the original circular armor steel wires of the cable core, or the original circular armor steel wires are replaced with Z-shaped inner-layer armor steel wires, and another layer of Z-shaped outer-layer armor steel wires is armored outside the Z-shaped inner-layer armor steel wires, so as to form a double armor layers integrally, so that the sealing effect is good. Two adjacent Z-shaped steel wires can be well embedded together with a small gap, playing a role of sealing under the action of an external pressure. Moreover, the inner and outer layers of the Z-shaped steel wires are armored in opposite directions, and the gaps of the inner and outer layers are staggered, so that the sealing effect is good.

### BRIEF DESCRIPTION OF THE DRAWINGS

FIG. 1 is a structural schematic diagram according to Embodiment 1 of the present disclosure;

FIG. 2 is a structural schematic diagram according to Embodiment 2 of the present disclosure;

FIG. 3 is a structural schematic diagram of a cable core according to Embodiment 3 of the present disclosure;

FIG. 4 is a structural schematic diagram of a cable core according to Embodiment 4 of the present disclosure;

FIG. 5 is a structural schematic diagram of a cable core according to Embodiment 5 of the present disclosure;

FIG. 6 is a structural schematic diagram of a cable core according to Embodiment 6 of the present disclosure;

FIG. 7 is a structural schematic diagram of a cable core according to Embodiment 7 of the present disclosure; and

FIG. 8 is a structural schematic diagram of a cable core according to Embodiment 8 of the present disclosure.

Reference numerals: 1 cable core, 2 circular inner-layer armor steel wire, 3 Z-shaped inner-layer armor steel wire, 4 Z-shaped outer-layer armor steel wire, 51 first conductor, 61 first insulator, 52 second conductor, 62 second insulator, 71 first filler layer, 72 second filler layer, 81 first wrapping tape, 82 second wrapping tape, 9 optical fiber, 10 grease filler, 11 steel tube jacket, and 12 lining layer.

### DETAILED DESCRIPTION OF THE EMBODIMENTS

The present disclosure is further described in conjunction with the accompanying drawings and embodiments.

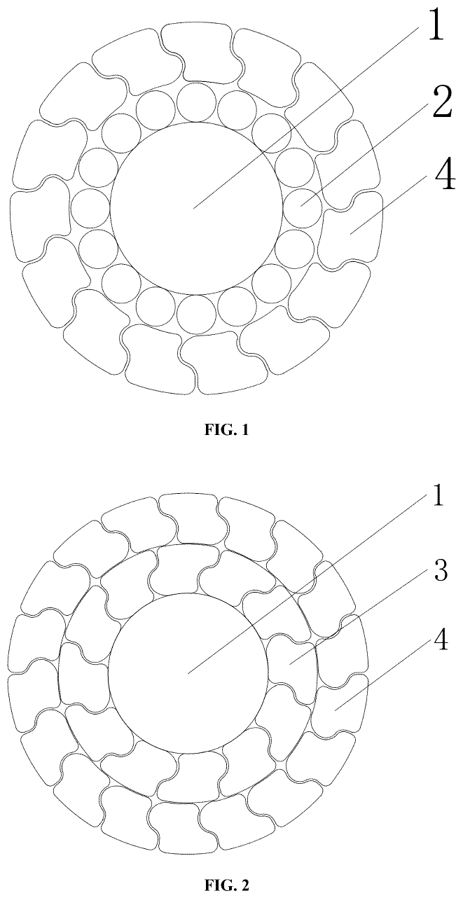

Referring to FIG. 1, Embodiment 1 provides a Z-shaped steel wire sealed load-bearing detection cable, including a cable core 1 and armor steel wire layers armored outside the cable core 1. The armor steel wire layers include an inner layer and an outer layer. The inner layer is formed by armoring circular inner-layer armor steel wires 2, and the outer layer is formed by armoring Z-shaped outer-layer armor steel wires 4. The circular inner-layer armor steel wires 2 are armored outside the cable core 1, and the Z-shaped outer-layer armor steel wires 4 are armored outside the circular inner-layer armor steel wires 2.

In this embodiment, another layer of Z-shaped outer-layer armor steel wires are armored outside original circular armor steel wires of the cable core, so as to form double armor steel wire layers. Two adjacent Z-shaped steel wires can be well embedded together with small a gap therebetween, thereby improving the sealing effect.

Referring to FIG. 2, Embodiment 2 provides a Z-shaped steel wire sealed load-bearing detection cable, including a cable core 1 and armor steel wire layers armored outside the cable core 1. The armor steel wire layers include an inner layer and an outer layer. The inner layer is formed by armoring Z-shaped inner-layer armor steel wires 3, and the outer layer is formed by armoring Z-shaped outer-layer armor steel wires 4. The Z-shaped inner-layer armor steel wires 3 are armored outside the cable core, and the Z-shaped outer-layer armor steel wires 4 are armored outside the Z-shaped inner-layer armor steel wires 3. The Z-shaped inner-layer armor steel wires 3 and the Z-shaped outer-layer armor steel wires 4 are armored in opposite directions.

Preferably, the Z-shaped inner-layer armor steel wires 3 and the Z-shaped outer-layer armor steel wires 4 each have a tensile strength not less than 1500 MPa. The two layers of Z-shaped steel wires with the tensile strength of not less than 1500 MPa that are armored in opposite directions are armored on the outer insulation layer of the cable core, where the adjacent Z-shaped steel wires can be well embedded together to play a role in sealing under external pressure. In this embodiment, a Z-shaped steel wire with a small cross-section ranging from 0.8 mm² to 2.5 mm² is used, and the small-sized Z-shaped steel wires are closely arranged, and an overall armored outer diameter ranges from 5.6 mm to 12.8 mm.

In this embodiment, two adjacent Z-shaped steel wires can be well embedded together, with a small gap therebetween. Moreover, the inner and outer layers of the Z-shaped steel wires are armored in opposite directions, and gaps in the inner and outer layers are staggered, so that the sealing effect is good.

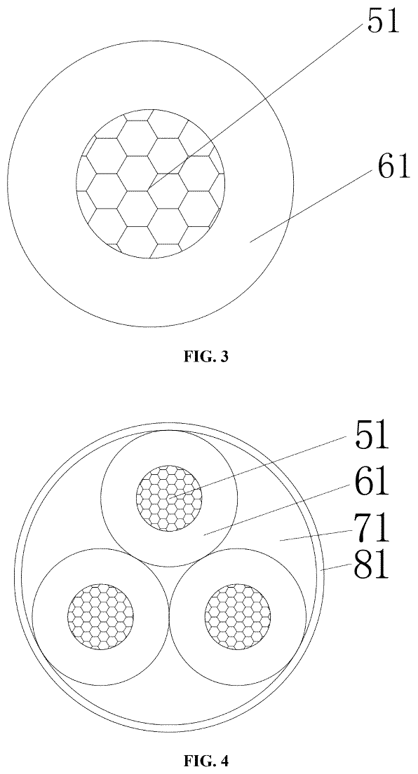

The cable core 1 is of any structure. The cable core 1 is described below referring to several structures shown in FIG. 3 to FIG. 8. The number of cores of the insulation wire core is not limited to these listed in the accompanying drawings, and generally, the insulation wire core includes cores of one to seven.

Referring to FIG. 3, in Embodiment 3, the first insulation wire core includes one core. The wire core includes a first conductor 51 and a first insulator 61. The first insulator 61 is extruded outside the first conductor 51. The circular inner-layer armor steel wires 2 or the Z-shaped inner-layer armor steel wires 3 are armored outside the first insulator 61.

Referring to FIG. 4, in Embodiment 4, the first insulation wire core includes three cores. The three cores of the wire core are stranded at a specific pitch to form a cable. A first filler layer 71 is added in the middle of the cable core, and a first wrapping tape 81 is wrapped outside the cable core to form the cable core 1.

Referring to FIG. 5, in Embodiment 5, the first insulation wire core includes four cores. The four cores of the wire core are stranded at a specific pitch to form a cable. A first filler layer 71 is added in the middle of the cable core, and a first wrapping tape 81 is wrapped outside the cable core to form the cable core 1.

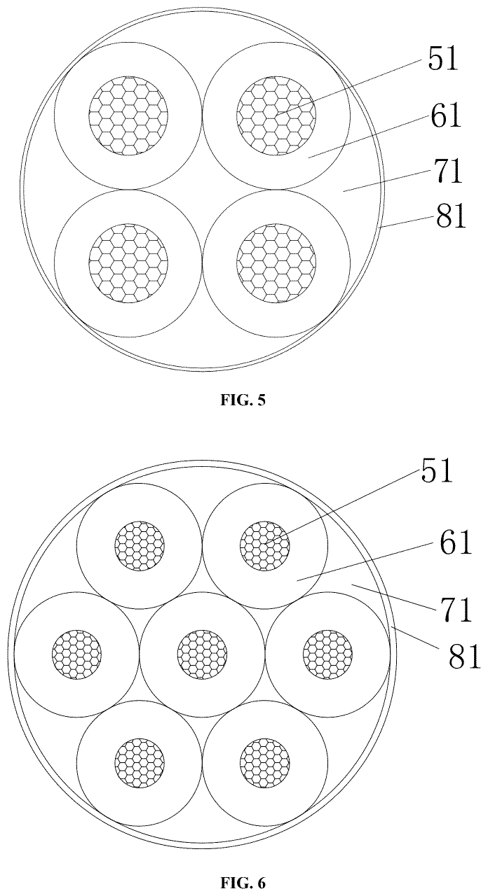

Referring to FIG. 6, in Embodiment 6, the first insulation wire core includes seven cores, where one core of the wire core is disposed at a central part, and the remaining six cores of the wire core are stranded at a specific pitch to form a cable. A first filler layer 71 is added in the middle of the cable core, and a first wrapping tape 81 is wrapped outside the cable core to form the cable core 1.

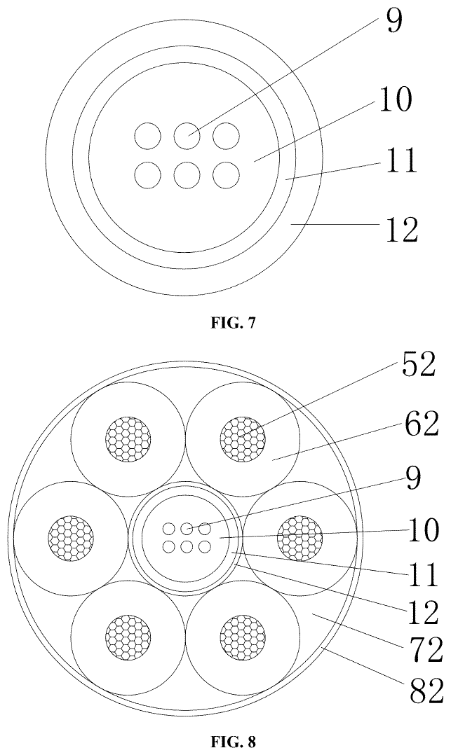

As required, the optical fiber unit can be added. The optical fiber unit includes optical fibers 9, a grease filler 10, a steel tube jacket 11, and a lining layer 12. Referring to FIG. 7, in Embodiment 7, the optical fiber unit can be used independently. The steel tube jacket 11 is sleeved outside the multiple optical fibers 9, the grease filler 10 is disposed between the steel tube jacket 11 and the multiple optical fibers 9, and the lining layer 12 is disposed outside the steel tube jacket 11.

The optical fiber unit can also be integrated into the cable as required. Referring to FIG. 8, in Embodiment 8, the cable core 1 further includes second insulation wire cores (power cords). The multiple second insulation wire cores (power cords) are stranded circumferentially around the optical fiber unit to form a cable, a second filler layer 72 is added in the middle of the cable core, and a second wrapping tape 82 is wrapped outside the cable core. The second insulation wire core (power cord) includes a second conductor 52 and a second insulator 62, where the second insulator 62 is extruded outside the second conductor 52.

In addition, a conventional armor layer, that is formed by armoring circular armor steel wires, has an outer surface not smooth because outer side faces of the circular armor steel wires are raised outward, resulting that the cable is serious in wear when running in and pulling out of a well, thereby shortening the service life of the cable. The armor layer, that is formed by armoring the Z-shaped armor steel wires, has a smooth surface, which greatly reduces the cable wear when the cable runs in and pulls out of the well, prolongs the service life of the cable, and reduces the construction costs.

What is claimed is:

1. A Z-shaped steel wire sealed load-bearing detection cable, comprising a cable core (1) and armor steel wire layers armored outside the cable core (1), wherein the armor steel wire layers comprise an inner layer and an outer layer, the inner layer is formed by armoring circular inner-layer armor steel wires (2) or Z-shaped inner-layer armor steel wires (3), the outer layer is formed by armoring Z-shaped outer-layer armor steel wires (4), the circular inner-layer armor steel wires (2) or the Z-shaped inner-layer armor steel wires (3) are armored outside the cable core, and the Z-shaped outer-layer armor steel wires (4) are armored outside the circular inner-layer armor steel wires (2) or the Z-shaped inner-layer armor steel wires (3).

2. The Z-shaped steel wire sealed load-bearing detection cable according to claim 1, wherein the Z-shaped inner-layer armor steel wires (3) and the Z-shaped outer-layer armor steel wires (4) are armored in opposite directions.

3. The Z-shaped steel wire sealed load-bearing detection cable according to claim 1, wherein the cable core (1) comprises a first insulation wire core, the first insulation wire core comprises a first conductor (51) and a first insulator (61), and the first insulator (61) is extruded outside the first conductor (51).

4. The Z-shaped steel wire sealed load-bearing detection cable according to claim 3, wherein the first insulation wire core comprises a plurality of first insulation wire cores, the plurality of first insulation wire cores are stranded into a cable, a first filler layer (71) is added in a middle of the cable core, and a first wrapping tape (81) is wrapped outside the cable core.

5. The Z-shaped steel wire sealed load-bearing detection cable according to claim 1, wherein the cable core (1) comprises an optical fiber unit, the optical fiber unit comprises optical fibers (9), a grease filler (10), a steel tube jacket (11), and a lining layer (12), the steel tube jacket (11) is sleeved outside the optical fibers (9), the grease filler (10) is disposed between the steel tube jacket (11) and the optical fibers (9), and the lining layer (12) is disposed outside the steel tube jacket (11).

6. The Z-shaped steel wire sealed load-bearing detection cable according to claim 5, wherein the cable core (1) further comprises second insulation wire cores, the second insulation wire cores are stranded circumferentially around the optical fiber unit to form a cable, a second filler layer (72) is added in a middle of the cable core, and a second wrapping tape (82) is wrapped outside the cable core.

7. The Z-shaped steel wire sealed load-bearing detection cable according to claim 6, wherein each of the second insulation wire cores comprises a second conductor (52) and a second insulator (62), and the second insulator (62) is extruded outside the second conductor (52).

8. The Z-shaped steel wire sealed load-bearing detection cable according to claim 3, wherein the Z-shaped inner-layer armor steel wires (3) and the Z-shaped outer-layer armor steel wires (4) are armored in opposite directions.

9. The Z-shaped steel wire sealed load-bearing detection cable according to claim 8, wherein the first insulation wire core comprises a plurality of first insulation wire cores, the plurality of first insulation wire cores are stranded into a cable, a first layer (71) is added in a middle of the cable core, and a first wrapping tape (81) is wrapped outside the cable core.

10. The Z-shaped steel wire sealed load-bearing detection cable according to claim 5, wherein the Z-shaped inner-layer armor steel wires (3) and the Z-shaped outer-layer armor steel wires (4) are armored in opposite directions.

11. The Z-shaped steel wire sealed load-bearing detection cable according to claim 10, wherein the cable core (1) further comprises second insulation wire cores, the second insulation wire cores are stranded circumferentially around the optical fiber unit to form a cable, a second filler layer (72) is added in a middle of the cable core, and a second wrapping tape (82) is wrapped outside the cable core.

12. The Z-shaped steel wire sealed load-bearing detection cable according to claim 7, wherein the Z-shaped inner-layer armor steel wires (3) and the Z-shaped outer-layer armor steel wires (4) are armored in opposite directions.
